(19) United States
(12) Patent Application Publication
(10) Pub. No.: US 2023/0008255 A1
(43) Pub. Date: Jan. 12, 2023

(54) PRIVACY PROTECTION FOR ELECTRONIC DEVICES IN PUBLIC SETTINGS

(71) Applicant: Anirban Mukherjee, Hamburg (DE)

(72) Inventor: Anirban Mukherjee, Hamburg (DE)

(73) Assignee: Quoori Inc., San Francisco, CA (US)

(21) Appl. No.: 17/368,383

(22) Filed: Jul. 6, 2021

(51) Int. Cl. G06F 21/84; G06K 9/00; G10L 25/51

(52) U.S. Cl. CPC G06F 21/84; G06K 9/00718; G06K 9/00228; G06K 9/00288; G10L 25/51

(57) ABSTRACT

A system for protecting privacy of electronic material is provided. The system comprises an electronic device comprising processor and memory, a display screen, a front facing camera, and an application executing on the processor. The application captures initial video content of objects facing the device and establishes a safe environment based on the captured initial content. The application also continually captures video content after establishment of the safe environment. The application also detects a deviation from the safe environment based on the continually captured video content. The application also determines the deviation is a threat and performs an action to address the threat based on the determination. The safe environment includes at least a user of the device and persons known to the user. Deviations are detected by tracking human faces facing the display screen. The tracked human faces are of persons physically behind the user and proximate the user.

### FIELD OF THE INVENTION

The present disclosure is in the field of protecting privacy of information. More particularly, the present disclosure provides systems and methods of an electronic device with a display screen and front-facing camera to initially capture a safe environment of a user, and thereafter repeatedly capture the environment, and warn the user and possibly take action when video captured subsequent to the initial capture contains faces of persons not appearing in the initial capture.

### BACKGROUND

Users of mobile devices and other electronic devices wishing to protect their private information may be vulnerable when primarily in public places to parties engaging in “shoulder surfing.” Such parties may stand behind a device user and literally look over the user's shoulder as the user views confidential material or makes entries of personal information such as account numbers, addresses, usernames, and passwords.

For the device user, being able to detect situations where his/her data may be at risk is a first step toward protecting it. With their eyes focused on the device, users are often oblivious to changes in their surroundings where a person of ill intent might gaze into the same display screen without being noticed by the user.

Such attempts to surreptitiously view and capture a device user's private information may be performed either at close range (by directly looking over the victim's shoulder) or from a longer range, for example by using binoculars or similar hardware. Attackers do not require any technical skills; keen observation of victims' surroundings and the typing pattern is sufficient. Crowded places, for example airports and railroad/bus stations are the more likely areas for an attacker to engage in this activity.

### BRIEF DESCRIPTION OF THE FIGURE

FIG. 1 is a block diagram of components and interactions of a system for privacy protection for electronic devices in public settings according to an embodiment of the present disclosure.

### DETAILED DESCRIPTION

Systems and methods described herein provide for a mobile device user to receive warnings and be prompted to take corrective action when “shoulder surfing” as described above may be occurring. “Over the shoulder” observers, nefarious spying parties, or simply curious persons may be surreptitiously observing the device's displayed content or the user's actions with the device.

A privacy protection application is provided that executes and activates a privacy protection mode on the mobile device with a display screen and a front-facing camera. The application is a face detection and classification system. Upon activation at the beginning of a session, the application captures video or at least one still image of the user and perhaps persons with the user who are trusted by the user.

This initial action establishes a “safe environment” of trusted persons that the application will use as a baseline in evaluating subsequent captured video segments during the session. The safe environment describes the persons determined to be authorized to view the screen of the device. The presence of other persons found to be possibly observing the device, most likely situated proximate but behind the user, may cause the application to determine that a threat is in effect, that those other persons may be attempting to view and possibly record the device's displayed material. When the application makes such a determination of potential threats, it notifies the user who can take various actions including obscuring or darkening the screen or even ending the session.

The application alternatively or in addition to capturing images or audio may also similarly establish a baseline safe environment sound or audio level. The application may then periodically sample volume and other characteristics of sound in the vicinity of the user. As with video, if the application detects a change in sound around the user that the application deems to suggest a threat, the application may warn the user.

The system is configurable by the user as to what constitutes a threat, how and when the user should be warned, and what options the user has given the circumstances. The application may be automatically invoked when the device is started such that by default the application is running at all times unless specifically disabled by the user. Alternatively, the application may be manually activated by the user. Also, the application may be automatically activated upon occurrence of an event, such as the starting of a word processing application, a white board application, or meeting software. If the user is presented with screens that call for the user to enter credentials, account numbers, or other confidential information, the application may also be automatically activated.

The system uses face detection to identify human faces and face classification to identify individual faces as separate ones. The system then tracks the faces in real time in subsequent video frames. As noted, the system performs audio detection to detect changes in sound conditions in the environment of the device user.

The application may be configured for possible conditions that qualify to be a threat situation including detection of new human faces facing the display screen. When such new faces are detected, the application determines if those new faces are close to the display screen.

When a threat is detected, the system may take a variety of actions that are user configurable options. The system may create a high contrast vignette near the edges of the screen to obscure the angle of visibility of the content on the display screen. The system may create a pre-defined overlay pattern display atop the displayed content. The system may turn down the brightness of the display screen or turn off the display screen completely. The system may display an alert message on top of the screen content warning that unauthorized persons may be viewing the screen content. The system may also emit an audio alert sound.

The system may be configured by the user to allow the user to delay or effectively “snooze” corrective action by the system when a threat has been detected. If the user chooses to “snooze” corrective action, then the system will honor that and may return the displayed content on the display device back to the conditions it was in, before the response action to the threat was taken. The system may also remember and treat the last detected “threat” condition as a “safe” environment. Any future re-occurrences of this same situation may be considered as “safe” and the system will not trigger any actions for it.

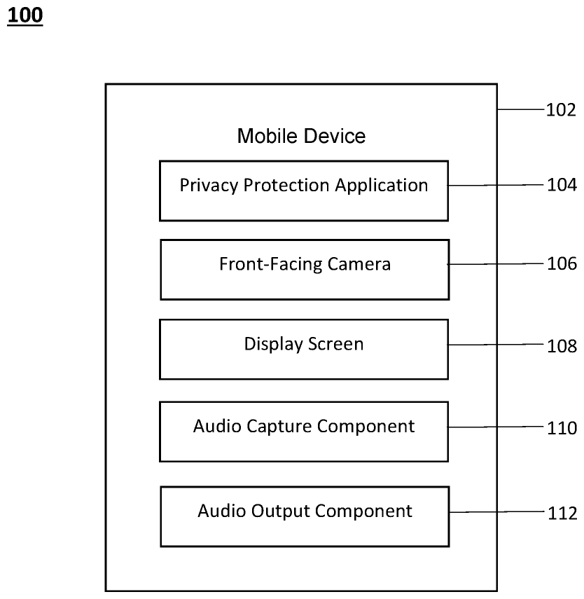

Turning to the figures, FIG. 1 depicts a system 100 of privacy protection for mobile devices in public settings. The system 100 comprises a mobile device 102 and a privacy protection application 104 executing thereon, which includes a front-facing camera 106 and a display screen 108, standard hardware features on most cell phones. The mobile device 102 also includes an audio capture component 110 and audio output component 112.

While the mobile device 102 has been characterized above as the sole type of hardware device that may support systems and methods provided herein, in embodiments other types of electronic devices may perform the function of the mobile device 102 as described herein. Tablet computers, notebook computers, laptop computers and even non-portable devices such as televisions may perform the functions described herein, as long as such devices support the privacy protection application 104 and include the other components provided herein and depicted in FIG. 1.

Several use cases are provided below. These use cases are provided as non-limiting examples of how systems and methods provided herein may be used.

In a first use case, a group of people gathers in a public place for a meeting and uses a mobile device 102 as described herein. One of the participants is named Douglas. The application 104 is activated to display confidential data relevant to the meeting that the group will view. As Douglas is present in the environment when the privacy protection mode is switched on and the safe environment created, Douglas is considered as part of the safe environment. In the event Douglas leaves the meeting and then returns, the system will not consider this event as Douglas (his previously captured face) is already part of the safe environment.

In a second use case, a group of persons sitting in a meeting area uses a single mobile device 102 with the application 104 executing thereon to display confidential data relevant to the meeting. A “safe” environment captured by the application 104 consists of the faces of the persons viewing the display screen when the application 104 is activated. If a new person, for example Ted, enters the meeting area, the system can detect it as a threat and respond with an alert overlaid on the displayed content on the display screen. The alert can have a “snooze” option along with it. If the user of the device 102 chooses the “snooze” action, then if Ted leaves the area and comes back again, the system will not recognize the situation as a threat.

In yet a third use case, a user of the device 102 is viewing content on the device 102 with their headphones plugged in. A change in environmental sound conditions may be a threat condition from which the user may desire protection. This scenario could occur when the user is viewing confidential material while riding on public transportation and an intrusive person approaches from behind. Because of poor lighting conditions on the bus or train, the intrusive person's face might not be clearly detectable. However, the sound of the person walking may be interpreted as the person possibly viewing the user's confidential material from behind.

In an embodiment, a system for protecting privacy of electronic material is provided. The system comprises an electronic device comprising processor and memory, a display screen, a front facing camera, and an application executing on the processor. The system captures initial video content of objects facing the device and establishes a safe environment based on the captured initial content. The system also continually captures video content after establishment of the safe environment and detects a deviation from the safe environment based on the continually captured video content. The system also determines the deviation is a threat and performs an action to address the threat based at least on the determination. The safe environment includes at least a user of the device and persons known to the user. Deviations are detected by tracking human faces facing the display screen. The human faces being tracked are one of complete faces and partial parts of human faces with certain landmarks comprising eyes, hair, and forehead. The tracked human faces are of persons physically behind the user and proximate the user. The application performs face classification to identify individual faces as separate ones, and then tracks the individual faces in real time in subsequent video frames. The system additionally captures audio content and determines a when a deviation in captured audio is a threat. The performed action comprises at least one of the application creating a high contrast vignette proximate edges of the screen to obscure an angle of visibility of displayed content, the application creating a predefined overlay pattern display atop displayed content, the application turning down brightness of the display screen, the application turning off the display screen completely, the application displaying an alert message atop displayed screen content warning that unknown person(s) are presently inside the safe environment, and the application creating an audio alert sound. The application is invoked one of upon device startup, by user action, and automatically upon at least one of startup of a user application and by display of fields requesting entry of confidential information.

In another embodiment, a privacy protection system is provided. The system comprises a portable electronic device with display screen and front-facing camera and a first application executing on the device. The first application receives activation and records one of an image and a video clip including a user of the device to establish an initial environment. The first application thereafter captures one of video content and still image content of the user and background at predetermined intervals.

Based at least on the captured content, the first application determines that the established initial environment has adversely changed, and recommends an action based on the determination. The system emits one of a visual and an audible alarm upon detecting a deviation from previously captured audio content. Activation is one of manual entry by user and automatic via detection of an event. The event is one of invocation of a user application and display of at least one field requesting entry of confidential information. Changes are identified by tracking at least partial human faces facing the display screen after establishment of the initial environment, and wherein the adverse change is identified based on presence of at least one human face not appearing in the initial environment.

In yet another embodiment, a method for promoting electronic device privacy is provided. The method comprises an electronic device with a display screen and a front facing camera capturing a first video content and capturing a second video content. The method also comprises the device determining that the second video content includes human faces not appearing in the first video content. The method also comprises the device determining that the second visible content constitutes a threat and recommending an action based on the determinations. The method also comprises the device classifying the first visible content as constituting a safe environment. The method also comprises the device capturing a third and a fourth visible content. The method also comprises the device making determinations whether the third and the fourth visible content constitute threats. The method also comprises the device one of additionally and alternatively recording and evaluation audio content proximate the device to make further determinations regarding potential threats.

What is claimed is:

1. A system for protecting privacy of electronic material, comprising:
an electronic device comprising:
processor and memory;
a display screen;
a front facing camera; and
an application executing on the processor that:
captures initial video content of objects facing the device, establishes a safe environment based on the captured initial content, continually captures video content after establishment of the safe environment, detects a deviation from the safe environment based on the continually captured video content, determines the deviation is a threat, performs an action to address the threat based at least on the determination.

2. The system of claim 1, wherein the safe environment includes at least a user of the device and persons known to the user

3. The system of claim 2, wherein deviations are detected by tracking human faces facing the display screen.

4. The system of claim 3, wherein the human faces being tracked are one of complete faces and partial parts of human faces with certain landmarks comprising eyes, hair, and forehead.

5. The system of claim 2, wherein the tracked human faces are of persons physically behind the user and proximate the user.

6. The system of claim 2, wherein the application performs face classification to identify individual faces as separate ones, and then tracks the individual faces in real time in subsequent video frames.

7. The system of claim 1, wherein the system additionally captures audio content and determines a when a deviation in captured audio is a threat.

8. The system of claim 1, wherein the performed action comprises at least one of the application creating a high contrast vignette proximate edges of the screen to obscure an angle of visibility of displayed content, the application creating a predefined overlay pattern display atop displayed content, the application turning down brightness of the display screen, the application turning off the display screen completely, the application displaying an alert message atop displayed screen content warning that unknown person(s) are presently inside the safe environment, and the application creating an audio alert sound.

9. The system of claim 1, where the application is invoked one of upon device startup, by user action, and automatically upon at least one of startup of a user application and by display of fields requesting entry of confidential information.

10. A privacy protection system, comprising:
a portable electronic device with display screen and front-facing camera; and
a first application executing on the device that:
receives activation, records one of an image and a video clip including a user of the device to establish an initial environment, thereafter captures one of video content and still image content of the user and background at predetermined intervals, based at least on the captured content, determines that the established initial environment has adversely changed, and recommends an action based on the determination.

11. The system of claim 10, wherein the system additionally captures audio content proximate the device.

12. The system of claim 11, wherein the system emits one of a visual and an audible alarm upon detecting a deviation from previously captured audio content.

13. The system of claim 10, wherein activation is one of manual entry by user and automatic via detection of an event.

14. The system of claim 13, wherein the event is one of invocation of a user application and display of at least one field requesting entry of confidential information.

15. The system of claim 10, wherein changes are identified by tracking at least partial human faces facing the display screen after establishment of the initial environment, and wherein the adverse change is identified based on presence of at least one human face not appearing in the initial environment.

16. A method for promoting electronic device privacy, comprising:
an electronic device with a display screen and a front facing camera capturing a first video content;
the device capturing a second video content;
the device determining that the second video content includes human faces not appearing in the first video content;
the device determining that the second visible content constitutes a threat; and
the device recommending an action based on the determinations.

17. The method of claim 16, further comprising the device classifying the first visible content as constituting a safe environment.

18. The method of claim 16, further comprising the device capturing a third and a fourth visible content.

19. The method of claim 18, further comprising the device making determinations whether the third and the fourth visible content constitute threats.

20. The method of claim 16, further comprising the device one of additionally and alternatively recording and evaluation audio content proximate the device to make further determinations regarding potential threats.
